(19) United States
(12) Patent Application Publication
(10) Pub. No.: US 2011/0316697 A1
(43) Pub. Date: Dec. 29, 2011

(54) SYSTEM AND METHOD FOR MONITORING AN ENTITY WITHIN AN AREA

(75) Inventors: Nils Oliver Krahnstoever, Schenectady, NY (US); Ting Yu, Albany, NY (US); Kedar Anil Patwardhan, Latham, NY (US)

(73) Assignee: GENERAL ELECTRIC COMPANY, SCHENECTADY, NY (US)

(21) Appl. No.: 12/825,774

(22) Filed: Jun. 29, 2010

(51) Int. Cl. G08B 21/00; G06K 9/46; H04N 7/18

(52) U.S. Cl. 340/540; 382/190; 348/143

(57) ABSTRACT

A system and method for monitoring an entity within an area is disclosed. The method includes specifying at least one criterion associated with an event of interest. The at least one criterion is specified visually on a display screen. At least one entity to be monitored is identified, and a movement of the at least one entity is captured visually on the display screen. The captured movement of the entity comprises at least one attribute associated with the at least one entity.

### BACKGROUND

The subject matter disclosed herein relates generally to surveillance techniques and, more particularly, to a video surveillance method and a system for monitoring an entity visually, within an area, based on the entity behavior.

Video surveillance is widely used for providing continuous surveillance across one or more locations. For example, railway stations, airports, prisons, banks, shopping complexes, and other public places or high security areas are routinely monitored using video surveillance. While video surveillance is helpful in monitoring current activity, it has also been successfully employed in reviewing recorded data to identify events of interest, after such events have occurred. For example, in case of theft in a shopping complex, recorded video surveillance data may be effectively used to identify individuals suspected of stealing from the shopping complex.

However, conventional video surveillance techniques and solutions may not be very effective in automatically notifying and/or alerting an operator of the occurrence of an event of interest, for example, suspicious behavior of an individual in a shopping complex, and similar places. Further, video surveillance systems may be difficult to configure in diverse application scenarios, and may require skilled personnel to configure and/or operate the video surveillance systems. While advanced technologies such as person detection and tracking are available, most video surveillance systems are not intuitive, and the associated data may not be intuitive to assess and/or analyze. Furthermore, analysis after an event has occurred, for example, analyzing recorded video surveillance data may usually be a cumbersome task. In certain instances, such recorded data may not provide details on specific events of interest that may have occurred. Accordingly, while many underlying video surveillance technologies have been developed, there exists a gap in the system capabilities and convenient operator usage of the system.

Therefore, there exists a need for an easy to configure and use system and method for monitoring an entity in an area.

### BRIEF DESCRIPTION

According to an embodiment, a method for monitoring an entity within an area includes specifying at least one criterion associated with an event of interest. The at least one criterion is specified visually on a display screen. At least one entity to be monitored is identified, and a movement of the at least one entity is captured visually on the display screen. The captured movement of the entity comprises at least one attribute associated with the at least one entity.

According to another embodiment, a system for monitoring an entity within an area includes an input and output device comprising a display screen, at least one image capture device and a monitoring module. The input and output device is configured to receive at least one criterion associated with an event of interest, the at least one criterion specified visually on a display screen. The at least one image capture device is configured to provide visual images of the area and at least one entity within the area. The monitoring module is configured to identify at least one entity to be monitored, visually capture a movement of the at least one entity on the display screen. The captured movement of the entity comprises at least one attribute associated with the at least one entity.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of a system for monitoring an entity within an area, according to an embodiment of the invention.

FIG. 2 illustrates an area to be monitored, for example, by the system of FIG. 1.

FIG. 3 illustrates the monitored area as seen on a user interface (UI), according to an embodiment of the invention.

FIGS. 4A, 4B, 4C, 4D depict movements of two entities as tracked on by the system, according to an embodiment of the invention.

FIGS. 5A, 5B, 5C illustrate monitoring the entities as seen on the user interface (UI), in accordance with an embodiment of the invention.

FIG. 6 illustrates the UI screen showing generated alerts, according to an embodiment of the invention.

FIG. 7 is a flowchart illustrating a method for monitoring an entity within an area, according to an embodiment of the invention.

### DETAILED DESCRIPTION

As described in detail below, various embodiments disclosed herein provide a method and a system for monitoring an entity within an area. The embodiments provide an interface that allows an operator (or a user) to configure the system for monitoring an entity visually on a display unit, such as a video screen, for example. Easy and intuitive interface allows for configuring the system according to the desired application, without requiring highly trained personnel. For example, a small convenience store on a highway may need a different configuration than a bank in a city, and the system may be configured by an average user/operator without requiring a high level of training. Further, the system allows for easy monitoring/tracking an entity because of its intuitive interface, and provides automated alerts and other monitoring operations in an easy to understand manner. The system also provides easy to comprehend analysis of recorded events, for example, by graphically representing the movement and temporal parameters of the monitored entities, on a visual display unit. The system also provides automated recording in detail of events of interest, for a later analysis of the recorded data.

Specifically, various embodiments disclosed herein provide a system and a method for monitoring an entity within an area, to assist operators in detecting suspicious behavior, or other behaviors or events of interest. For example, the system detects when an entity, such as an individual, moving in the field of view of one or more cameras, fulfills operator specified criteria relating to an event of interest, and the system then notifies the operator via sound and/or text-to-speech commands of the occurrence of an event. The system provides a close up view of the individual that caused the event, and further keeps track of the individual as the individual leaves the area where the event occurred. Specifically, the system first detects and tracks an entity (an individual or other moving objects, if desired) in the field of view of one or more surveillance cameras. An operator can specify events of interest denoted by various constraints, for example, geometrical constraints (person crossing line, entering or leaving zone, standing at a location) and temporal constraints (dwelling at certain location for certain amount of time). The operator can furthermore determine the actions that the system takes when an event of interest is detected. Once an individual in the field of view of a camera fulfills the specified criterion, the system creates an event notification through the previously specified alerts. The system further shows the event of interest on the screen, and provides a focused monitoring of the individual of interest, for example, the individual that caused the event. Such an individual of interest is tagged by the system (i.e., the system creates a record of the individual). When the individual subsequently leaves the field of view of the camera from which the event was detected, the system automatically switches camera views to display the track of the tagged individual. Advantageously, the operator does not need to perform any action while the system automatically tracks the individual moving within the field of view of various cameras, switching the camera views if required. The system is configurable to detect events automatically, perform alerts (e.g. audio notification), and continually tracks the individual using one or more available surveillance cameras. Based on the activity of the individual, the operator may take appropriate actions, such as apprehending the individual, or dismissing the event triggered by the individual as benign.

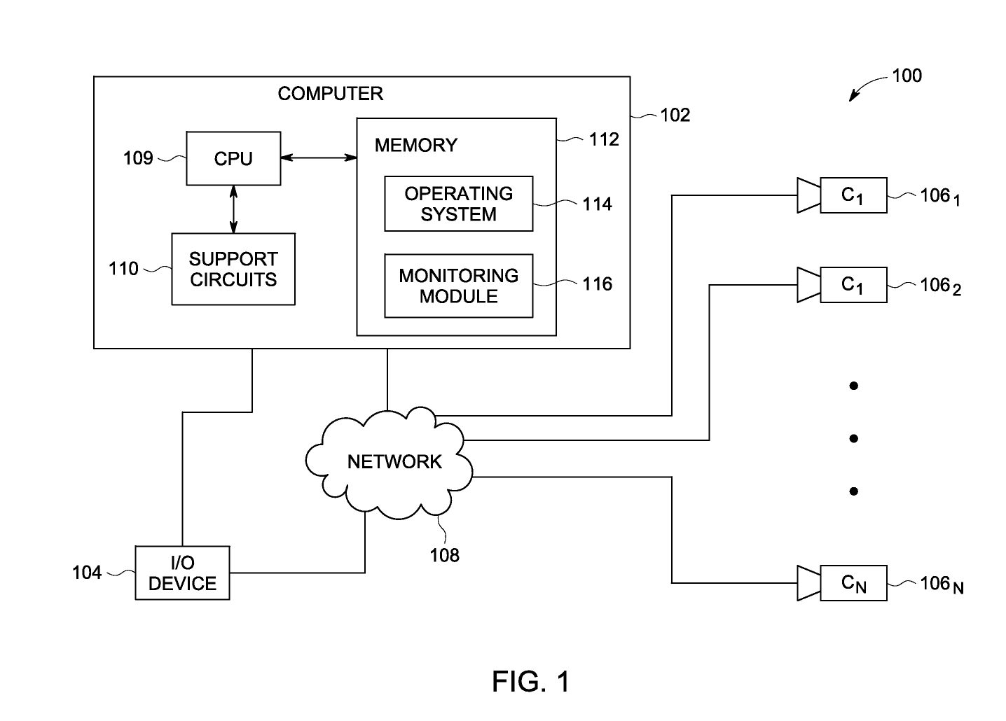

Referring now to FIG. 1, a system 100 for monitoring an entity within an area is illustrated according to an embodiment of the present invention. As used herein, the term “entity” includes a person, an animal, or an object of interest. The system 100 includes a computer or a server 102, an input and output device 104, one or more image capture devices, such as cameras, 106₁, 106₂ . . . 106_{N}, generally denoted by the numeral 106 operably coupled to each other. In the illustrated embodiment, the computer 102, the input and output device 104 and the cameras 106 are operably coupled through a network 108. In alternate embodiments, the computer 102, the input and output device 104 and the cameras 106 are electronically coupled to each other directly, for example using a wired or a wireless medium. According to various embodiments, image data acquired by image capture devices 106 is communicated to the computer 102, the computer 102 may control the image capture devices 106, and an operator controls the computer 102 and/or the image capture devices 106 from the input and output device 104. The computer 102, the input and output device 104 and the image capture devices 106 are operably coupled, for example, using the network 108, or other techniques such as those generally known in the art.

The computer 102 is a computing device (such as a laptop, a desktop, a server class machine, a Personal Digital Assistant (PDA) and/or the like), generally known in the art. The computer 102 comprises a CPU 109, support circuits 110, and a memory 112. The memory 112 stores operating system 114, and a monitoring module 116. The CPU 109 may comprise one or more commercially available microprocessors or microcontrollers that facilitate data processing and storage. Various support circuits facilitate operation of the CPU 109 and may include clock circuits, buses, power supplies, input/output circuits and/or the like. The memory 112 includes a Read Only Memory, Random Access Memory, disk drive storage, optical storage, removable storage, and the like. The operating system 114 generally manages various computer resources (e.g., network resources, data storage resources, file system resources and/or the like). The operating system 114 performs basic tasks that include recognizing input, sending output to output devices, keeping track of files and directories and controlling various peripheral devices. The operating system 114 provided on the computer 102 may be MS-DOS®, MS-WINDOWS®, OS/2®, UNIX®, Linux®, or any other known operating system.

The monitoring module 116 includes steps necessary for monitoring an entity according to various embodiments described herein. Those skilled in the art will appreciate that the monitoring module 116 may take any form known in the art, for example, an analog or digital microprocessor or computer, and it may be integrated into or combined with one or more controllers used for other functions related to the video surveillance and monitoring. The steps necessary for monitoring an entity according to various embodiments, may be embodied in hardware, software and/or firmware in any form that is accessible and executable by a processor, e.g. CPU 109, and may be stored on any medium, such as memory 112, that is convenient for the particular application.

The input and output device 104 includes input and output means, such a keyboard and/or a mouse, a touch screen, among others for example, that a user can use to enter data and instructions into the system 100. The input and output device 104 also includes an output means such as a display unit, for example, a video screen, to allow a user to see what the computer 102 has accomplished. Other output devices may include a printer, plotter, synthesizer and audio speakers. The input and output device 104 provides a user interface (UI) for an operator to use the system 100 for monitoring an entity.

Image capture devices 106 include, for example, video cameras such as digital cameras, analog cameras and the like. The image capture devices may provide colored or black and white image data. The image capture devices are capable of capturing images, or a string of images in color or black and white format, with sufficient resolution, and provide such images in a readable format to the computer 102. The image capture devices are configured to provide an output of the image (or string of images) captured such that the image data may be processed for monitoring an entity, combining images from several image capture devices, among other operations. The image capture devices may include closed circuit television (CCTV) cameras or surveillance cameras such as those generally known in the art, and the terms “image capture device” and “camera” have been used interchangeably for the purpose of this discussion. According to various embodiments, the image capture devices interface with the computer 102 through a frame grabber (not shown in FIG. 1), such as those generally known in the art. The cameras include PTZ (pan, tilt, zoom) cameras that the computer 102 controls automatically, for example, to capture an entity's motion in detail if the entity caused an event of interest, or based on an operator command. Further, the monitoring module 116 (or the system 100) is configured to switch display from one image capture device to another image capture device based upon the movement of the entity in the field of view of the corresponding image capture device.

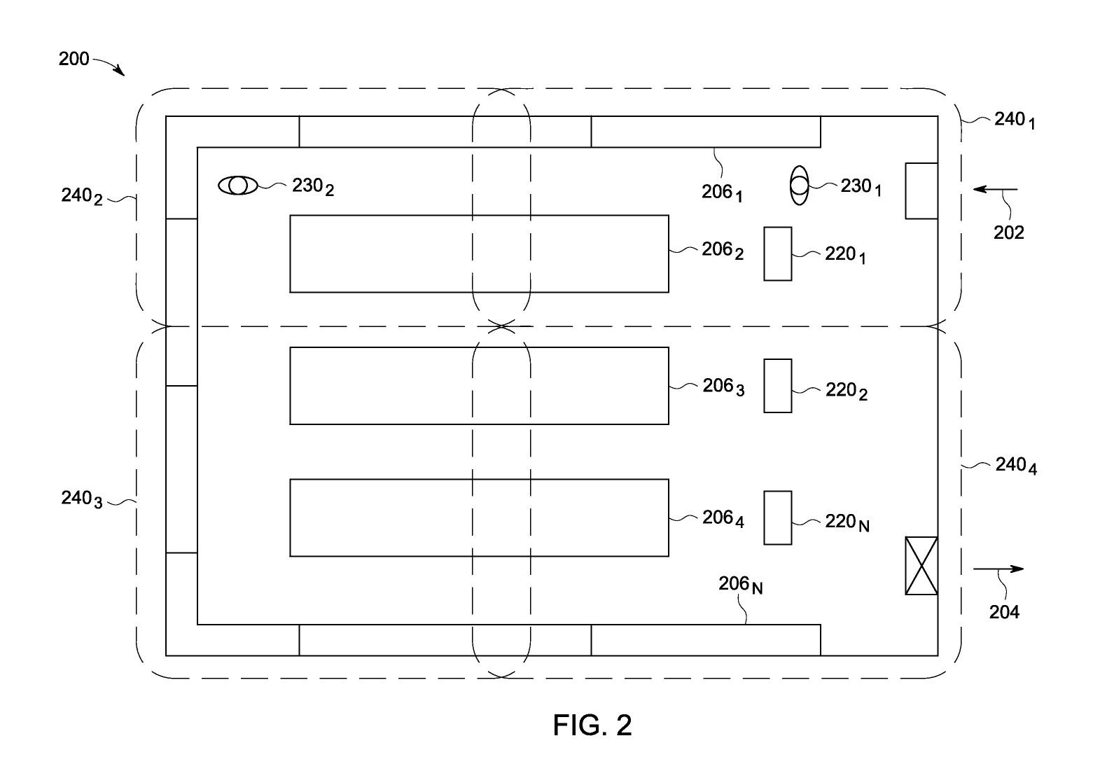

According to an embodiment, FIG. 2 illustrates an area 200 being monitored using a system and a method for monitoring an entity. The area 200 may include various sites that can be monitored, such as shops, banks, railway stations, airports, prisons, and the like. In the illustration of FIG. 2, the area 200 represents a schematic of a shop, however, such a representation is not intended to limit various embodiments discussed herein, but rather as an illustration that may readily be extended to other areas, as will occur readily to those skilled in the art.

The area 200 includes an entry 202, an exit 204, multiple zones containing saleable items, for example multiple racks 206₁, 206₂ . . . 206_{N} denoted generally by the numeral 206, and multiple cash counters 220₁, 220₂ . . . 220_{N} represented generally by numeral 220. Various entities 230₁, 230₂ . . . 230_{N} to be monitored, generally represented by numeral 230, are present in the area 200. The area 200 is monitored by one or more cameras (not shown in FIG. 2), for example, similar to the image capture devices 106 of FIG. 1. Depending on the field of view of the cameras, the one or more cameras may monitor sub-zones within the area 200. In the illustration of FIG. 1, multiple zones denoted generally by the numeral 240 (240₁, 240₂ . . . 240_{N}) are defined such that each zone is monitored by at least one camera. The output of one or more cameras may be configured to provide a combined view of the area 200. In other embodiments, the area 200 may be monitored by a single camera.

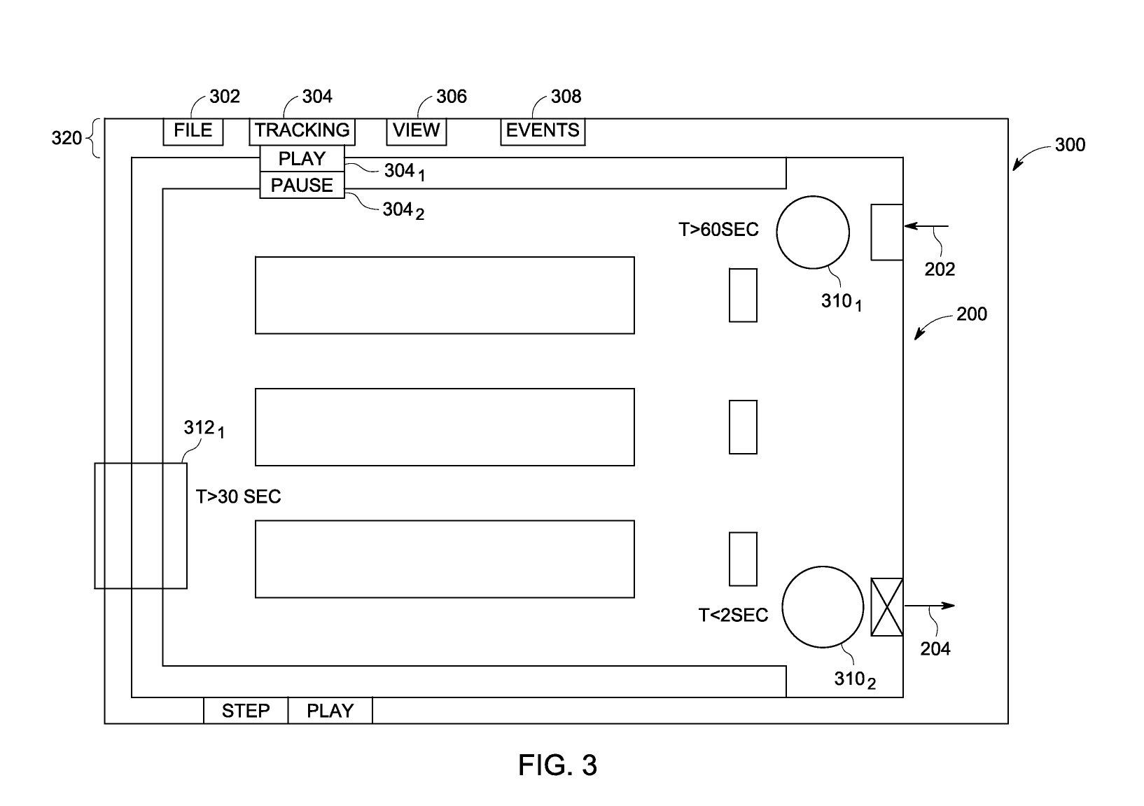

FIG. 3 illustrates a user interface (UI) 300 configured on an input an output device, for example, similar to the input and output device 104 of the system 100, according to an embodiment. The UI 300 comprises a display unit, such as video screen, showing the area 200 or at least a portion thereof, in a user interactive window. The UI 300 is usable by an operator for configuring, using and analyzing from the system 100 for monitoring an entity. The UI 300 includes a menu 320 for operating the system 100, including providing options to an operator for monitoring an entity, for example, configuring, using and analyzing video surveillance data obtained by the system 100. The menu 320 provides several options for use through sub menus, for example, file 302, tracking 304, view 306, and events 308. The tracking 304 sub menu includes options to play 304₁ or pause 304₂ a camera feed. The menu 320 of FIG. 3 is shown for illustrative purposes, and other configurations of the menu 320, and well-understood functionalities for operating the system 100 are included within the scope and spirit of the various embodiments presented herein.

FIG. 3 illustrates configuration of the system 100, for example, by an operator. The entities to be monitored are not shown in the illustration of FIG. 3. The operator configures the system 100 by defining events of interest. The operator further configures the system 100 to monitor and/or track such events, record movements of entities associated with event in detail, generate alerts for the operator on the occurrence of such events, among others. Events of interest include one or more actions or movements of the entity being monitored. The actions and/or movements of the entity are identifiable based on the entity meeting certain criterions or constraints, such as location or geometrical constraints, direction of movement constraint, and time constraints. For example, the location or geometrical criterion include constraints on the location attributes associated with the movement of the entity. The location or geometric attributes of movement include a position of the entity, and can be used to identify if the entity crosses a line, stays within a geometrical shape, for example a circle, a rectangle or a square, among others. The direction of movement attribute includes direction of movement of the entity with respect to directions of interest within the area, for example, direction of entry, exit, or general pattern of browsing within the area. The time attributes include time spent at a particular location, time taken in traversing a distance, among others. In the example of a shopping complex illustrated by the area 200, events of interest may include actions or movements of the entity that indicate potential shoplifting. Such actions or movements of the entity may be identified by fulfillment of relevant criterions associated with the event and/or the entity. The fulfillment of relevant criterions is ascertained by measuring the attributes associated with the entity, and if the measurement of such attributes crosses a predetermined threshold, the relevant criterion is fulfilled and an event of interest is identified.

For example, events of interest may include an entity moving out of the entry 202 of FIG. 2, or the entity spending a long amount of time at a particular location within the shopping complex, or the entity returning to a particular location repetitively, among several conceivable actions and/or movements of the entity. In this example, the associated criteria that are fulfilled are associated with a location of the entity, direction of movement of the entity and time spent by entity at a particular location. Specifically, attributes such as time spent by the entity at a particular location, number of times the entity returns to the particular location, direction of the movement of entity near the entry 202 of the area 200, are measured. If one or more of the measured attributes cross a threshold value, a criterion is met, and an event of interest is generated. For example, a threshold associated with the direction of movement attribute may govern that the direction of an entity's movement should be ‘moving in to the area’ in a region close to the entry 202, and accordingly, if an entity's movement is ‘moving out of the area’ the associated threshold is crossed. According to another example, a threshold associated with time spent by an entity may govern that an entity should spend no more than two minutes in front of a perfumes section, and accordingly, if an entity spends more than two minutes in front of the perfumes section, the threshold is crossed.

According to another embodiment, if the monitored area is a public place, such as a railway station, events of interest include the possibility of a terrorist activity, for example, an entity such as a luggage or a box being stationary for a long time, however, the associated criterion and attributes are similar, that is, the attributes include location or geometric constraints, time constraints, direction of movement constraints, or a derivation from such attributes. Those skilled in the art will appreciate that different environments being monitored have different events of interest, and embodiments disclosed herein provide for easy configuration of the system 100 for identifying, monitoring and tracking of different events of interest by an operator, without requiring a high level of training of skill.

Returning to the shopping complex example (area 200) illustrated in FIG. 3, an event of interest is defined using a time constraint, and a location and/or geometric constraint, such as an entity spending a long time, for example, more than 60 seconds, at a visually defined zone 310₁ near the entry 202. Spending a long time near the entry may indicate a potential shoplifter on a reconnaissance mission of the shopping complex before the actual shoplifting. Another event of interest is defined as an entity (e.g. an individual) crossing a visually defined zone 310₂ near the exit 204 in less than 2 seconds, indicating a shoplifter trying to escape out from the exit without paying for one or more of the items from the shopping complex. For an entity being monitored, one or more events of interest may be monitored in continuation. For example, if an entity is stationary within a predefined zone near the exit for more than a minute, and then the same entity crosses a predefined zone near the exit in less than 2 seconds, the system 100 may generate an alert indicating a higher level of suspicious, and potentially shoplifting activity. In another example for a shopping complex, an event may be defined by a direction of movement constraint, such as an entity moving in a direction out of the shopping complex through the entry 202, which is opposite to that of an expected movement. Yet another event of interest is defined by a time and geometric constraint, such as an entity spending more than 30 seconds within a visually defined zone 312 that is in front of an expensive item, for example, a high value and low size item, such as a digital camera or a watch, indicating a possibility of shoplifting. While in many cases, most shoppers may spend a long time contemplating buying an expensive item, statistical observations may easily provide threshold time limits that indicate a possibility of shoplifting versus a possibility of a shopper genuinely interested in buying an item. In yet another example (not illustrated in FIG. 3), an entity may spend a long time in the alcohol section, and then the same entity may spend a long time in the meat section, indicating that the entity is an individual may have loaded a large amount of alcohol and meat in a shopping cart. Based on specific known behaviors in a particular shopping complex, for example, a shopping complex near a university, such a behavior may indicate a person intending to shoplift for a party, and such an entity may be tracked for shoplifting.

For the shopping complex example, several other such behaviors may be configured to be monitored as events of interest by an operator of the system 100, and in many cases, such scenarios are dependent on the typical behavior observed in particular regions (e.g. different states or cities), particular districts within those regions (e.g. high income neighborhood, or highways, low income neighborhoods), among various others. In examples other than the shopping complex, for example, banks, public places and the like, similar variation exists in the behaviors that need to be monitored. Various embodiments discussed herein advantageously allow for configuring the system 100 for monitoring different behaviors and events of interest, by defining spatial and temporal constraints, for example, on a display screen, in a visual manner, using familiar or easily configurable geometrical shapes and time restrictions, among others.

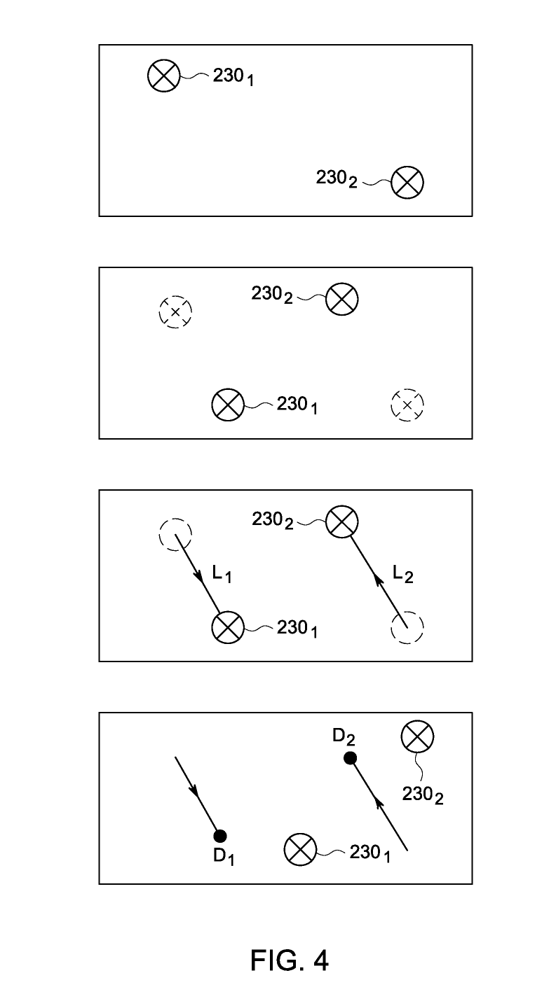

Referring now to FIGS. 4A-4D, monitoring of two entities 230₁ and 230₂ in a portion of the area 200 is illustrated. FIG. 4A illustrates an original position of the entities 230₁, 230₂ and in FIG. 4B, the entities 230₁, 230₂ have moved from their respective original positions of FIG. 4A indicated by dashed outlines, to new positions indicated by solid outlines. FIG. 4C illustrates vectors or lines L₁ and L₂ tracking the movement of the entities 230₁, 230₂ and according to various embodiments, the displacement and/or the direction of movement are tracked by the system 100. The entities 230₁, 230₂ may move further from their positions of FIG. 4B to other positions, as illustrated in FIG. 4D, and the system 100 continues to track the movement of the entities 230₁, 230₂ in a similar fashion. Accordingly, at any instant, the system is able to display or trace a track of an entity's movement within the area. The track so displayed is beneficial in monitoring the entities' 230₁, 230₂ movement effectively and efficiently, an intuitive manner.

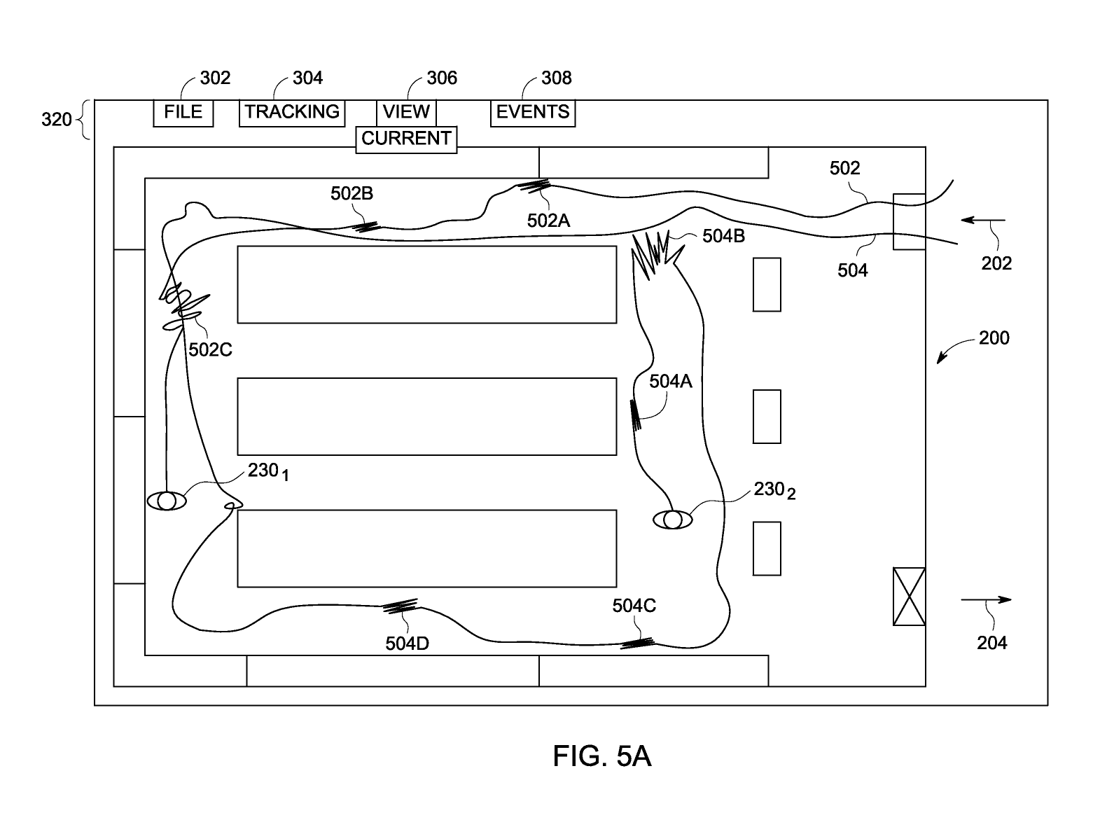

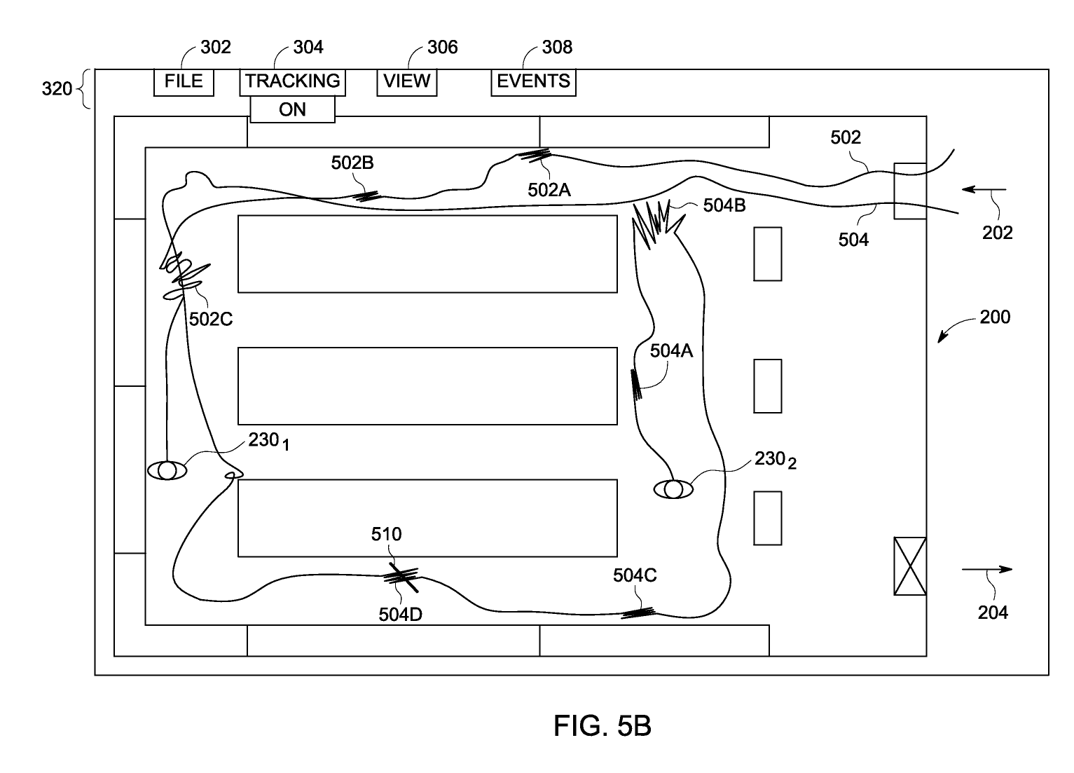

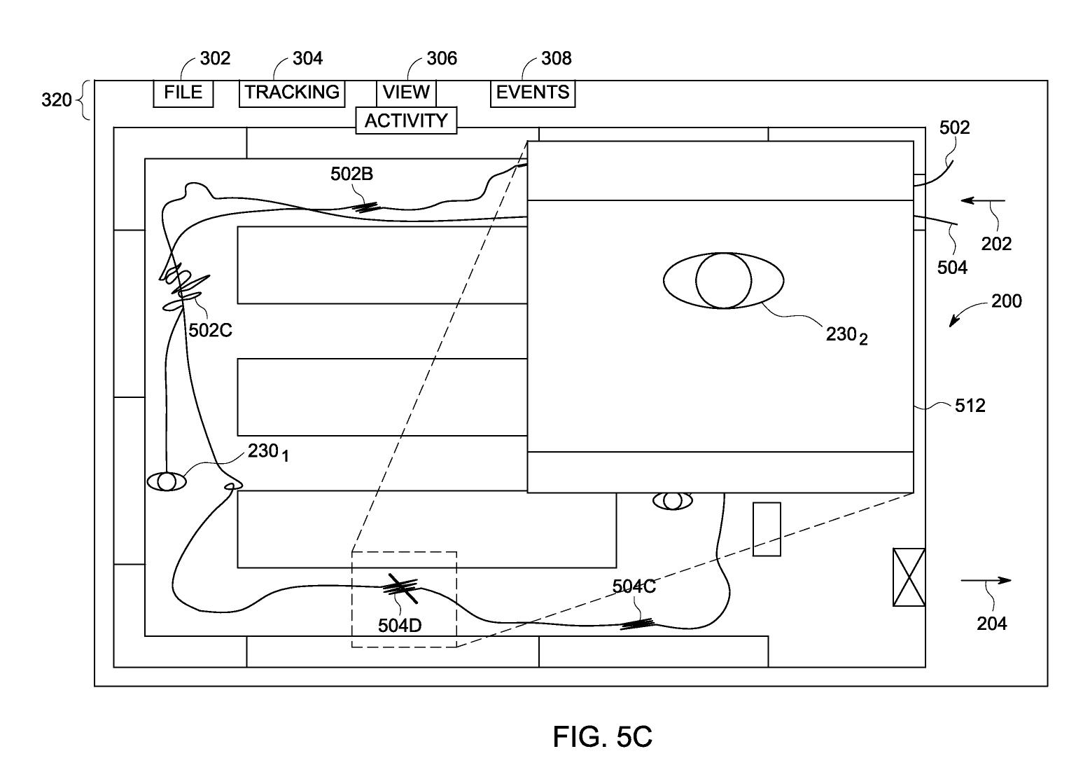

Referring now to FIGS. 5A, 5B and 5C, monitoring and tracking of the entities 230₁, 230₂ in the area 200 is illustrated. The system 100 is configured to generate a complete visual track of an entity's movement on the UI 300. For example, FIG. 5A illustrates tracks 502 and 504 that respectively denote the movement of the entities 230₁, 230₂ within the area 200, on the UI 300 display screen. In normal course of monitoring, the operator may choose to display such tracks on the display, for example, by activating the “CURRENT” mode in the view 306 menu option. Alternately, the operator may choose not to display the tracks for better visibility of the area on the UI 300. FIG. 5A illustrates that the entity 230₁ dwelled at locations 502A, 502B and 502C, while the entity 230₂ dwelled at locations 504A, 504B, 504C and 504D, as denoted by the track lines at these locations. In addition to viewing the entities, the operator may also monitor and/or track the past movements of each of the entities within the area at any instant, visually on the UI 300. FIG. 5B illustrates that a shopper (e.g., entity 230₂) dwelled at a location 504D, and the operator may monitor such a shopper by specifying a monitoring criterion including intuitive visual inputs, to the system 100. For example, the operator activates “ON” on the tracking 304 menu option, and specifies the monitoring criterion by drawing an intuitive visual input, for example, a line 510 across the track lines (visually captured movement of the entity 230₂) in the region 504_{D}. To view the movement of the entity 230₂ in the region 504D, the operator activates “ACTIVITY” option from the view 306 menu option, as illustrated by FIG. 5C. In response to such an input by the operator, the system 100 provides and/or displays a detailed record of the entity's 230₂ activity while in the region 504D. In alternate embodiments, the operator could provide other intuitive inputs, such as drawing a rectangle or circle around the region 504D to extract a visual summary of the entity 230₂ for the time the entity 230₂ was in the region 504D, or the entity generated a motion pattern matching an event of interest. According to an embodiment, FIG. 5C illustrates the system displaying the entity's 230₂ activity in a region 512, during its presence in the region 504D, for example, in the frame 512 on the UI 300. The frame 512 could be displayed in a picture-in-picture format as illustrated by FIG. 5C, or the UI 300 may display only the entity's 230₂ activity on the display screen, among several possible display configurations.

Further, if any of the entities 230₁, 230₂ cause an event to be triggered, the system 100 is configured to specifically monitor and track the actions of that entity in a focused manner, and further, the system 100 stores visual data pertaining to such actions of that entity. According to several embodiments, the system 100 advantageously allows for a detailed analysis of events of interest at a later time, without the operator requiring to tag such events or entities. Tagging an entity includes creating a record pertaining to the movement and activities of the entity, while tagging an event includes creating a record pertaining to the event and identification of all entities associated with the event.

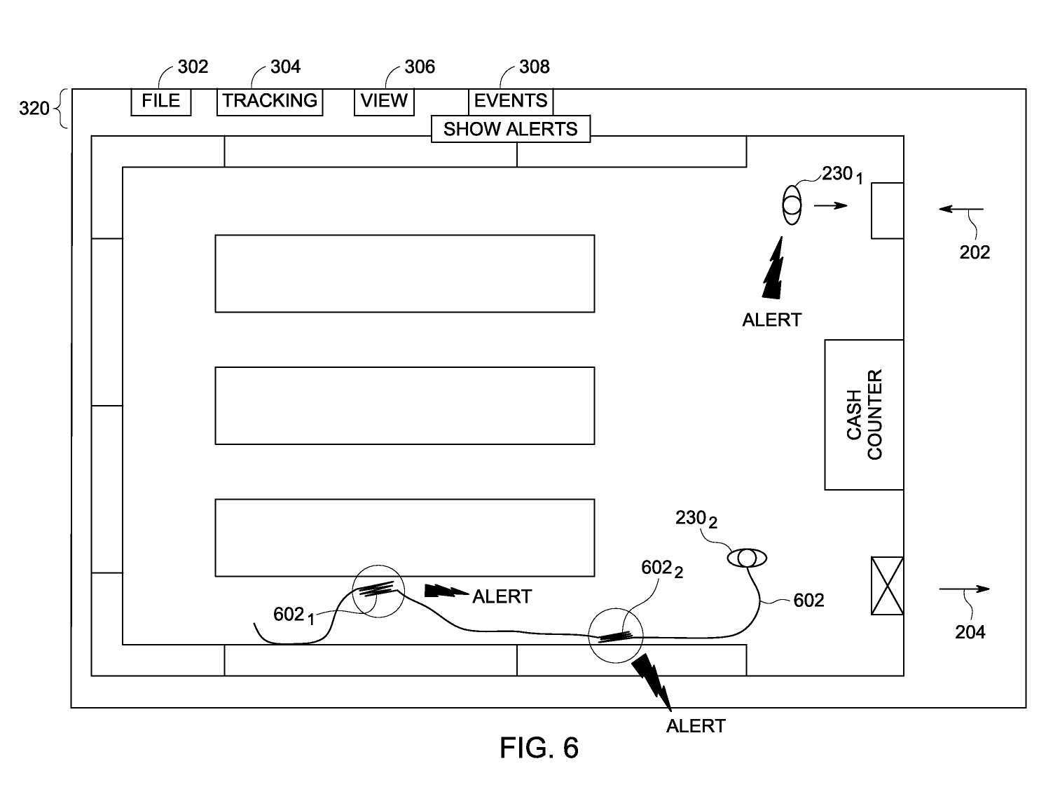

As illustrated by FIG. 6, in use, the system 100 alerts the operator at the occurrence of one or more events of interest. For example, the entity 230₁ is illustrated as attempting to move towards the entry 202 in the direction that indicates that the entity 230₁ is attempting or may attempt to exit the shopping complex from the entry 202, in which case the system generates an alert for the operator. As another example, an alert is generated when the entity 230₂ spends a long time (for example, more than 15 minutes) at two locations represented by positions 602₁ and 602₂ respectively, as illustrated by the partial track 602. According to an embodiment, alerts may be generated for the operator of the system 100, and/or for other personnel within the area, for example the area 200, or other agencies such as the police. In one scenario, the operator may attend to the alerts, and observe and/or analyze the events of interest in detail, and if no suspicious action is observed, the operator may decide that the event was benign and ignores the alerts. According to another scenario, the operator may observe suspicious activity by an entity, and may issue instructions for apprehending the entity. In other scenarios, for example, where the number of alerts matching a particular event of interest may be high, the operator may generally postpone viewing such events, and in such scenarios, the system 100 specifically records in detail, such events of interest, and movements of the entities associated with the event, for a later observation and analysis.

Alerts generated by the system 100 are informative, non-intrusive, and require minimal effort on behalf of the operator. For example, the alerts generated by the system include a combination of one or more of audio, advanced visualization and video analytics algorithms for generating alerts. According to an embodiment, the alert may be an audio signal such as a beep, a text to speech voice, for example; a visual signal such as a flashing text, an image or a color coded light; or a combination of such audio and visual alerts.

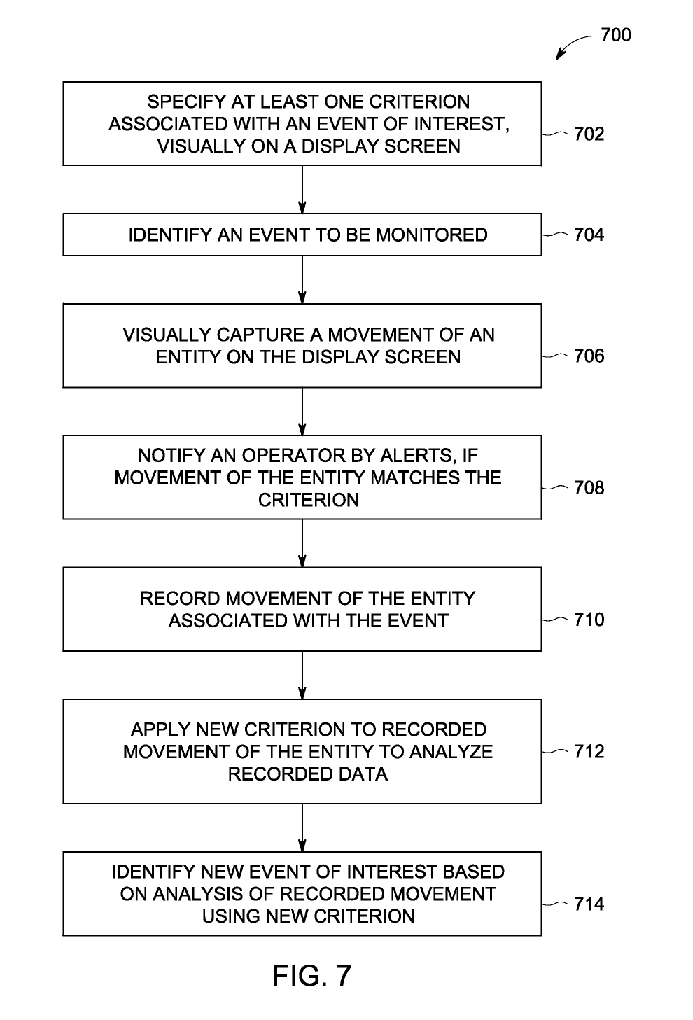

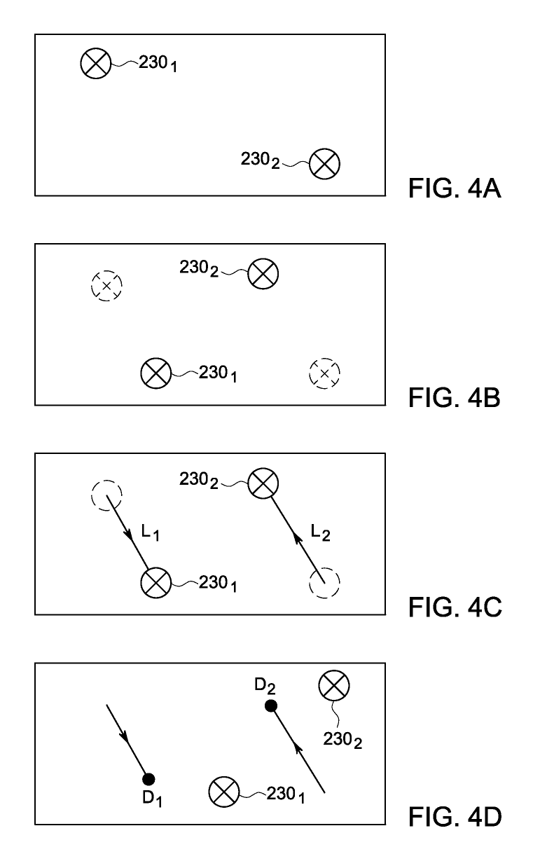

According to various embodiments, the operator may analyze recorded data associated with an event or an entity, by observing the movement patterns of the entity's movement and/or actions. For example, as illustrated by FIG. 5, a complete visual track of an entity's movement (502, 504) may be reproduced by the system 100, for example, on the UI 300 display screen for analysis. Further, the operator may define new events of interest that may be applied to the recorded data, to analyze the behavior of an entity. For cases in which a mishap, for example, a theft has occurred, analyses of the recorded data provide an easy and intuitive manner for the operator to identify suspects or miscreants related to the theft. In addition to viewing recorded data, other events of interest generated by the system 100 may be analyzed. Further, detailed data recorded for the entities related to events of interest may be analyzed. Furthermore, based on an observed pattern of theft, the operator may define new events of interest consistent with the pattern of theft, and use these new events of interest to analyze the recorded data to converge on potential suspects, for example. FIG. 7 illustrates a flow diagram of a method 700 for monitoring an entity within an area, according to one embodiment. At step 702, at least one criterion associated with an event of interest to monitored, is specified visually on a display screen, for example, by the operator. At step 704, an entity to be monitored is identified by the system. At step 706, the movement of the entity within the area is captured visually on the display screen. For example, the movement of the entity is captured as a line representing the actual path taken by an entity. According to certain embodiments, the movement of the entity at each location is tracked by marking rectangular shapes at the corresponding location. The rectangular shapes increase in size if the entity dwells at a location for a longer time. At step 708, if movement of the entity matches the specified at least one criterion, the operator is alerted or notified of an occurrence of an event of interest. Upon occurrence of an event of interest, at step 710, the movement of the entity associated with the event of interests is monitored in detail, including focusing the cameras on the entity, and such focused monitoring of the entity's movement is recorded, for example, for later analysis. In certain cases, for example, in case of a theft at a shopping a complex in which no suspects have been readily identified, additional analysis of recorded data needs to be made to identify possible culprits. In such scenarios, according to step 712, the operator may specify new criterions, or modify the previous criterions to re-analyze the recorded data. New events of interest consistent with the new or modified criteria are accordingly identified at step 714. FIG. 7 illustrates one embodiment of the method for monitoring an entity within an area, and those skilled in the art will readily appreciate modifications to the method 700 based on the various embodiments disclosed herein.

Various embodiments as discussed have a technical effect of providing techniques that optimally notify an operator of the occurrence of an event of interest, reducing the system-operator gap such that the operator may advantageously utilize the advanced surveillance technology to identify events of interest effectively and efficiently, with relative ease. A technical effect and an advantage of the embodiments is that video analytics, smart cameras are made convenient to use for an average operator, without requiring an inordinate amount of training or skill. Further, according to various embodiments, a technical effect is that an average operator can easily configure and reconfigure the system according to the various application scenarios, observed patterns etc. to improve the system efficacy. Advantageously for example, various embodiments discussed provide easy to comprehend, and intuitive geometrical shape attributes and time attributes for configuration of the system, monitoring an entity and analysis of recorded data use an intuitive GUI, in a familiar environment using one or more of a mouse, a screen and a keyboard, among others.

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable. The modifier “about” used in connection with a quantity is inclusive of the stated value and has the meaning dictated by the context (e.g., includes the degree of error associated with measurement of the particular quantity).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for monitoring an entity within an area, the method comprising:
specifying at least one criterion associated with an event of interest, the at least one criterion specified visually on a display screen;
identifying at least one entity to be monitored; and
visually capturing a movement of the at least one entity on the display screen, wherein the captured movement comprises at least one attribute associated with the at least one entity.

2. The method of claim 1 further comprising generating an alert if the at least one attribute matches the at least one criterion associated with the event of interest.

3. The method of claim 2, wherein the at least one attribute matches the at least one criterion when the at least one attribute crosses a predetermined threshold, the at least one criterion comprising the predetermined threshold.

4. The method of claim 1, wherein the at least one criterion is specified as at least one of a geometrical constraint, a location constraint, a direction of movement constraint, and a temporal constraint.

5. The method of claim 4, wherein the geometrical constraint comprises specifying a threshold as at least one of crossing a line, entering or leaving a zone within the area, and dwelling at a location within the area.

6. The method of claim 4, wherein the temporal constraint comprises specifying a threshold as an amount of time associated with a location of the at least one entity.

7. The method of claim 4, wherein the location constraint comprises specifying a threshold as presence at a particular location.

8. The method of claim 4, wherein the direction of movement constraint comprises specifying a threshold as an expected direction of movement at a portion within the area.

9. The method of claim 2, wherein the alert is at least one of an audio alert and a video alert.

10. The method of claim 1 further comprising specifying a monitoring criterion visually on a display screen to monitor the movement of the at least one entity in detail.

11. The method of claim 10, wherein the monitoring criterion is specified on the visually captured movement of the at least one entity.

12. The method of claim 1, wherein visually capturing a movement of the at least one entity comprises representation of a position of the at least one entity by rectangular regions, the size of the rectangular regions varying based upon the time spent by the at least one entity at the position.

13. The method of claim 1 further comprising modifying the at least one criterion visually on a display screen.

14. The method of claim 1 further comprising:
recording the event of interest in detail, and
tagging the at least one entity associated with the event of interest.

15. The method of claim 14 further comprising recording the movement of the at least one entity tagged as being associated with the event of interest.

16. A system for monitoring an entity within an area, the system comprising:
an input and output device comprising a display screen, the input and output device configured to receive at least one criterion associated with an event of interest, the at least one criterion specified visually on a display screen;
at least one image capture device configured to provide visual images of the area and at least one entity within the area; and
a monitoring module configured to identify at least one entity to be monitored, visually capture a movement of the at least one entity on the display screen, wherein the captured movement comprises at least one attribute associated with the at least one entity.

17. The system of claim 16 wherein the monitoring module is further configured to generate an alert through the input and output device, if the at least one attribute matches the at least one criterion associated with the event of interest.

18. The system of claim 16, wherein the at least one image capture device comprises a plurality of image capture devices, and wherein the monitoring module is configured to switch display from one image capture device to another image capture device based upon the movement of the entity in the field of view of the corresponding image capture device.

19. The system of claim 16, wherein the input and output device is configured to receive specification of the at least one criterion as at least one of a geometrical constraint, a location constraint, a direction of movement constraint, and a temporal constraint.

20. The system of claim 16, wherein the monitoring module is further configured to record the event of interest in detail, tag the at least one entity associated with the event of interest, and record the movement of the at least one entity tagged as being associated with the event of interest.

21. The system of claim 20, wherein the monitoring module is configured to receive and apply a modified criterion to analyze the recorded event of interest and/or the movement of the tagged entity.
